(19) United States
(12) Patent Application Publication
(10) Pub. No.: US 2026/0309577 A1
(43) Pub. Date: Oct. 8, 2026

(54) VIBRATION FREQUENCY RESPONSE CORRECTION METHOD AND SHAKER SYSTEM USING THE SAME

(71) Applicant: Crystal Instruments Corporation, Santa Clara, CA (US)

(72) Inventor: James Q Zhuge, Palo Alto, CA (US)

(73) Assignee: Crystal Instruments Corporation, Santa Clara, CA (US)

(21) Appl. No.: 19/284,592

(22) Filed: Jul. 29, 2025

Related U.S. Application Data
(60) Provisional application No. 63/782,561, filed on Apr. 2, 2025.

(51) Int. Cl. G01M 7/02; G01P 15/18

(52) U.S. Cl. CPC G01M 7/025; G01P 15/18

(57) ABSTRACT

Frequency response correction of smart vibration sensors employs frequency-domain compensation of sensor acceleration measurements and a table of frequency, amplitude, and phase triplets stored in a transducer electronic data sheet representing each smart sensor's frequency response function for complex number multiplication. The table is obtained in a pre-scan calibration method using a shaker table, a swept sine wave excitation, and a very accurate reference accelerometer for comparison. To obtain the phase response information, accurate time stamps are applied to both smart sensor and reference accelerometer measurement data to permit cross-spectrum analysis during calibration of the smart sensor. Stored frequency response compensation stored in the calibrated smart sensor data sheet is applied to acquired vibration data after transformation into the frequency domain, either on board the sensor or in a host computer.

### CROSS-REFERENCE TO RELATED APPLICATION

This application claims priority under 35 U.S.C. 119(e) from U.S. provisional patent application 63/782,561, filed Apr. 2, 2025.

### TECHNICAL FIELD

The present invention relates to shaker systems employing accelerometers, vibration sensors, smart transducers, or the like, with transducer electronic data sheets (TEDS) to store transducer sensitivity, calibration data, and other attributes according to a standard template or framework, and more specifically relates to use of stored TEDS data for the compensation of measurement errors as a function of vibration frequency.

### BACKGROUND ART

One of the critical specifications of a vibration sensor is its measurement accuracy across a specified frequency range of interest. Measurement accuracy can be described in the frequency domain based on the tolerance given. For example, a sensor claimed to have amplitude accuracy over the frequencies of interest within ±1.0 dB is much better than another claimed to be within ±2.0 dB. There are many reasons that a sensor can be out of tolerance during the usage. For a sensor manufacturer, it is their goal to design a sensor that the measurements are within the specified tolerance over the time and environment conditions that is claimed.

The largest cause of measurement deviation is due to the structure and mounting of the sensor itself. While a traditional vibration sensor that is based on piezoelectrical, charging, or MEM technology can be optimized so that its housing and mounting are rigid and small enough to overcome the resonance problems, a smart sensor that contains sophisticated electrical components inside usually has much larger size, hence having severe structural resonances over the measurement frequency. In other words, a smart sensor with a larger size is expected to experience more structural resonances, so the measurement accuracy of the sensor will easily exceed the tolerance.

As seen in FIG. 1, a smart vibration sensor 10 is a compact data acquisition system in the form of a three-axis accelerometer. FIG. 2 shows corresponding internal electronics of that smart sensor. It comprises one or multiple sensing components 11 that convert vibration movement into electrical signals, plus signal conditioning circuitry 13, Analog-to-Digital Converters (ADCs) 15, a CPU processor 17, nonvolatile memory 19, various wired and unwired interfaces 21, and battery power management 23. With such complexity of electrical components, usually the size of a smart sensor 10 is much larger than conventional piezoelectric or charge sensors. The mechanical structure is also much more complex. Due to the complexity of mechanical structure of the smart sensor, resonances and antiresonances of internal mechanical components and housing may generate various vibration feedback that results in a frequency response that is not flat.

FIG. 5 is a plot of the amplitude of a typical frequency response function (FRF) measured from a smart sensor against a standard calibration sensor. The standard calibration sensor acts as an accurate comparison base. To generate this plot, the smart sensor was mounted to the base of a vibration exciter with back-to-back fixture to the standard sensor. A swept sine signal was fed into the exciter sweeping through the frequency range of interest. An ideal FRF shall be a straight line at 0.0 dB. The deviation of FRF from 0.0 dB indicates measurement error of the smart sensor. The larger the deviation, the bigger the error of the smart sensor at that frequency. As seen, there are one or more peaks 25 and valleys 27 of the FRF amplitudes and corresponding shifts in phase response 26 from 0° up to as much as 180°. The shape of the FRF, including these peaks and valley, are very repeatable (a plot of separate FRF signals overlap quite well), which indicates that they are caused by the inherited structure of the smart sensor. The FRF signal also tells us whether the smart sensor is within the claimed tolerance. Commonly, a vibration sensor should measure the acceleration signals within ±1 dB or ±2 dB range across the claimed frequency range, depending on its desired application. Obviously, the smart sensor plotted here does not meet either requirement.

U.S. Pat. No. 7,331,209 to Saari et al. describes a transducer and accelerometer system that includes a compensator device (a digital or analog filter or combination of filters) storing generated compensation information to provide amplitude and phase compensation of the accelerometer (acceleration) or transducer (force or pressure) output signals based on a frequency response function, whereby the required frequency domain corrections are calculated. Both the input and output of the filter or combination of filters are time domain signals. If the compensator is an analog filter, then both input and output of the filter are continuous analog signals in the time domain. If the compensator is a digital filter, then both input and output of the filter are discrete digital signals in the time domain. An advantage is that the filter output signal can be obtained in real time, which is critical to most sensor applications. A disadvantage with analog filters is the restriction of the filter shape to one of just a few types (low-pass filter, high-pass filter, bandpass filter, notch filter). It is impossible to implement even a combination of such filters to compensate for a sensor having anything other than the simplest of frequency response functions. The flexibility of digital filters is better but will still have a very fixed shape. None of them can achieve a frequency accuracy of ±1.0 dB across an entire frequency range of interest for shaker systems.

Transducer Electronic Data Sheet (TEDS) sensors, as defined by the IEEE 1451.4 standard, emerged from a broader technological evolution involving smart sensors and embedded data storage. The concept of TEDS involves embedding an electronic datasheet (typically in an EEPROM) within a sensor to store information like manufacturer details, serial numbers, sensitivity and calibration data, enabling plug-and-play functionality for applications such as vibration measurements. In most TEDS sensors, a single sensitivity value is stored in the EEPROM inside the sensor. When the TEDS sensor is used, the instrument will read the stored sensitivity value of the sensor from the TEDS and apply that sensitivity value to the measurement to make a simple conversion of output voltage to a corresponding acceleration value.

National Instruments Corporation (as of October 2023, a part of Emerson Electric Co.) in a paper, “IEEE 1451.4 TEDS Sensor Templates Overview”, Jun. 22, 2023, and especially in the section “Standard Templates—Calibration Templates”, describes various TEDS calibration templates, including a frequency response table that allows the specification of the frequency response function of a sensor as a set of amplitude-frequency data pairs in a standard format. Such a detailed description of a sensor's frequency response in a readable table specific to the sensor would allow compensation via transformation (e.g., fast Fourier transform) of the input signal into the frequency domain, followed by amplitude corrections appropriate for each frequency, before transformation back into a time domain output signal. In many sensor applications this is adequate. However, a full frequency response function (FRF) compensation should also take the phase response into account, which is especially important in shaker systems that evaluate the vibration responses of various objects mounted on a shaker table. But in known current vibration sensors, representation of a complex number function (with both real and imaginary components) to characterize both amplitude and phase response of the sensor is not provided. This is believed to be due to the inability in known prior technologies to accurately measure phase deviations between two independent data acquisition systems. Without such a measure, only an array of amplitudes can be used as correction factors.

### SUMMARY DISCLOSURE

To meet the tolerance of vibration sensors in the considered frequency range given their structural complexity, a method is proposed to fully compensate the acquired spectrum in both amplitude and phase after FFT analysis. Sensors are calibrated to determine their frequency response function (FRF) for each sensor axis and a FRF correction table describing the complex number multiplication factors needed for each frequency are generated from the determined FRF, the table being stored in a memory unit of the sensor as similar to entries in a Transducer Electronic Data Sheet (TEDS) except that a phase column is added. That is, for each frequency entry, both amplitude and phase correction values are stored. During subsequent use of the calibrated sensors vibration measurements are taken, digitized and time stamped, then transformed from the time to frequency domains and then the FRF correction table entries are applied at each frequency. Finally, the compensated sensor measurements can then be transformed back into the time domain.

A method of sensor frequency domain calibration stores a frequency response function (FRF) correction table in a modified Transducer Electronic Data Sheet (TEDS) having entries in the form of frequency-amplitude-phase data triplets representing the sensor's frequency response function. The calibration used to generate the FRF correction table is performed via a comparison of time stamped measurements of a sensor being calibrated with those of an accurate reference sensor as both sensors are vibrated using a swept sine excitation. To limit the correction table's size in the TEDS, a set of breakpoints are established that are denser in frequency bands having rapid changes in response (in either the amplitude or phase component), generally near sensor resonances, but spaced further apart in bands where the rate of change in the response is gradual. The number of breakpoints is optimized to the required tolerances for the sensor measurement.

A shaker system has sensors with stored TEDS-like based data representing a complex frequency response function (FRF) of those sensors, using the TEDS-like based data to perform frequency domain compensation of sensor measurements. A shaker table is driven by an exciter receiving an amplified electric drive voltage controlled by a computer. An object under test is mounted on the shaker table with calibrated vibration sensors attached at specified locations on the object. The acceleration measurements recorded by each sensor are digitized as a time domain output signal and time stamped, then transformed into the frequency domain to generate an output spectrum signal, and amplitude and phase compensated via complex number multiplications using FRF correction information stored in the memory unit of the relevant sensor. These compensations can be performed either on board each sensor itself or by a host computer receiving the raw sensor measurement data along with the corresponding TEDS-like information for that sensor. As previously noted, to be able to correctly apply phase compensations, an accurate measurement of the sensor phase response is required. It is critical that both the time domain signals acquired in the smart sensor and the data acquisition system connected to the reference sensor be accurately time stamped. With time stamping information, the cross-spectrum (including its phase spectrum) can be calculated, as for example using the technique in this applicant's U.S. Pat. No. 11,754,724.

A method of frequency response function (FRF) correction of sensor measurements uses a stored TEDS-like table with entries in the form of frequency-amplitude-phase data triplets. Amplitude and phase compensation values can be represented by real and imaginary components of a complex number, in which case the compensation employs complex number multiplications to apply the TEDS compensation data to the sensor measurements in the frequency domain. Alternatively, the amplitude and phase compensation values can also be represented in polar coordinates as radius and angle components for each given frequency.

### BRIEF DESCRIPTION OF THE DRAWINGS

FIG. 1 is a perspective view of a smart sensor in the form of a three-axis accelerometer having internal electronics, including Transducer Electronic Data Sheet (TEDS) memory and CPU processor, for use in the present invention.

FIG. 2 is a block diagram of internal electronics contained by the smart sensor of FIG. 1.

FIG. 3 is a perspective view showing a smart sensor mounted on a shaker system for use first in calibrating smart sensors like that in FIG. 1, then subsequently for vibration analysis of objects using data acquisition from one or more calibrated smart sensors.

FIG. 4 is a block diagram of the components of a shaker system as in FIG. 3, and then data acquisition for vibration analysis using calibrated smart sensors.

FIG. 5 is a plot of a typical amplitude and phase versus frequency response of a smart sensor like that in FIG. 1, obtained using the shaker system in FIGS. 3 and 4, with acceleration measurement deviations from the smart sensor compared against a standard calibration sensor. Prior to calibration and the establishment of a corresponding compensation table, the frequency response of this smart sensor is seen to exceed ±1.0 dB.

FIG. 6 is a flow chart of the steps of a pre-scan smart sensor calibration method using the shaker system of FIGS. 3 and 4 according to the present invention.

FIG. 7 is a schematic view of a portion of a TEDS set of compensation table entries according to the present invention that corresponds to the determined frequency response of the smart sensor calibrated by the method in FIG. 6.

FIG. 8 is a flow chart of the steps using a calibrated smart sensor using stored TEDS compensation table entries according to the present invention to correct smart sensor measurements in the frequency domain.

FIG. 9 is a plot of amplitude and phase versus frequency response obtained after employing the compensation method in FIG. 8.

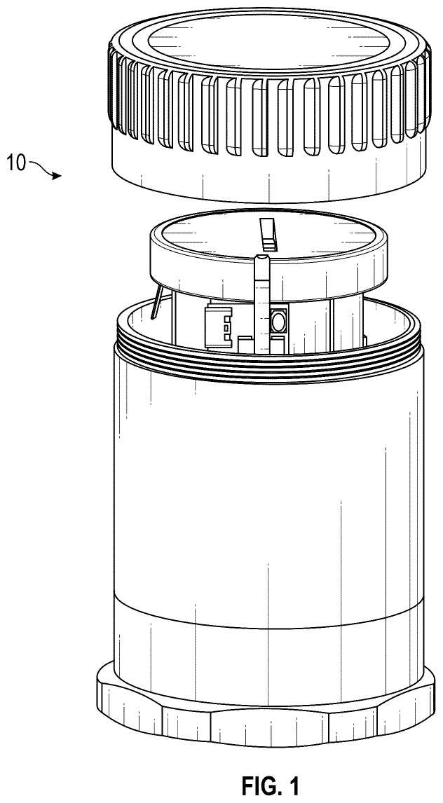

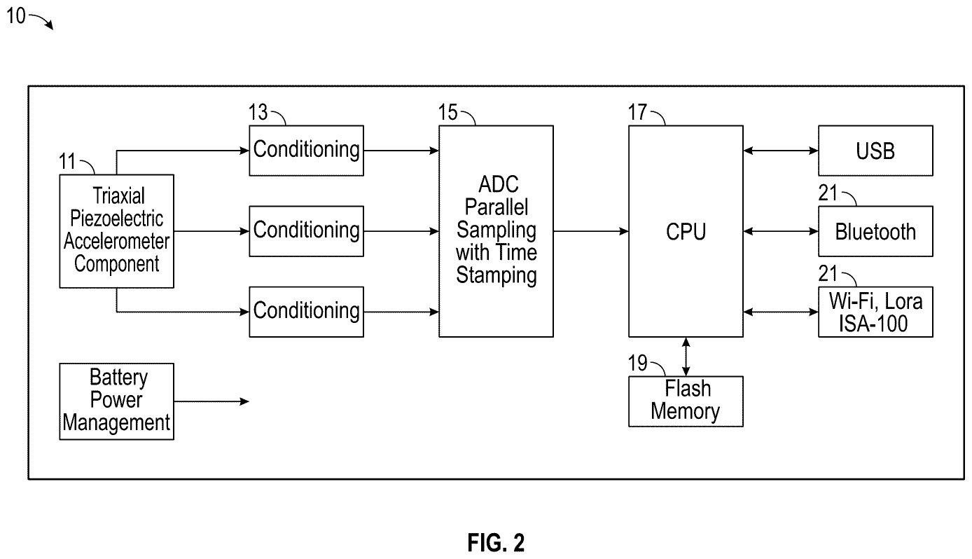

### DETAILED DESCRIPTION

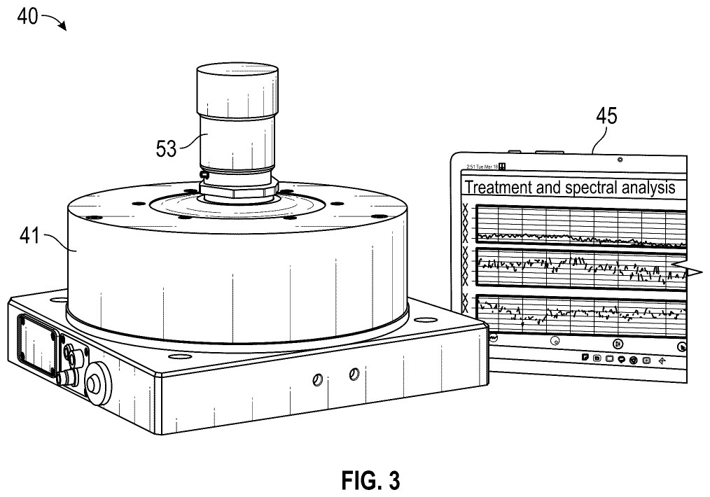

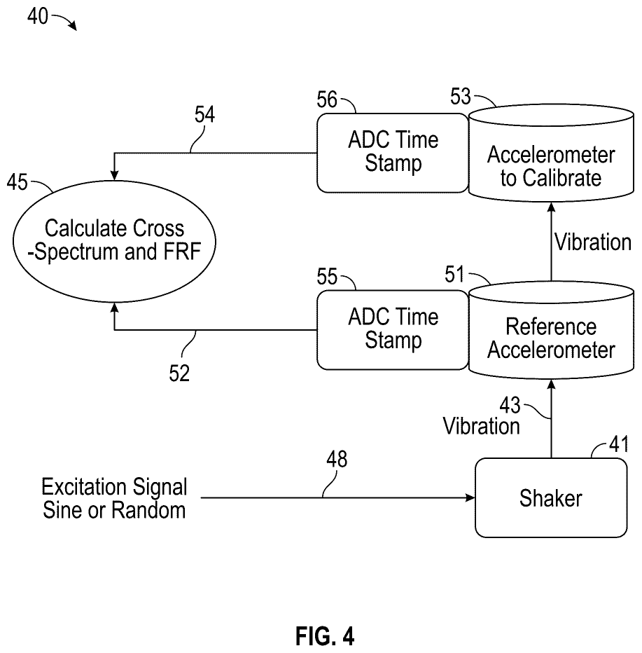

With reference to FIGS. 3 and 4, a shaker system 40 includes a shaker table 41 with vibration accelerations 43 generated by an exciter (receiving an electrical drive voltage signal 48). A controller (computer) 45 can generate a pure sine wave (as well as other possible excitation patterns) that drives the exciter via digital-to-analog converter and amplifier. At least the shaker table 41 itself, and usually also an object under test (initially a smart sensor 53 to be calibrated, then later in use any object subject to vibration analysis using the calibrated smart sensor) that is positioned upon the shaker table, has one or more sensors to measure the resulting acceleration and generate a voltage output signal 54. For calibration of those sensors 53, a reference sensor 51 with a measurement accuracy that is usually better than 1/10 of the frequency tolerance is also mounted on the shaker table which also generates a voltage output signal 52 representative of the measured acceleration. The sensor 53 to be calibrated must be mounted to the shaker table 41 and its exciter in the same direction as the reference sensor 51 for a true comparison of their respective measurements.

The respective analog signals of reference sensor 51 and of the sensor 53 to be calibrated will be sampled through different analog-to-digital converters (ADC). These ADCs are on different data acquisition units and are usually not synchronized. To calculate the phase of the frequency response function (FRF) between two sensors, the digitization times from these two devices must be stamped with accurate time information. Therefore, both data acquisition systems for sensors 51 and 53 have the capability to track the time and apply time stamps 55 and 56 to the respective digitized time-domain signal samples. For acceptable phase estimations a time stamp accuracy better than 100 ns between the respective samples is required. After the digitization and time stamping of the output time domain signals, processing techniques for correcting any phase mismatch between measurement data acquired from different recording units and for carrying out cross-channel spectral analysis of the measurement data as described in U.S. Pat. No. 11,754,724 will be used to calculate the cross-spectrum and FRF with phase information. In U.S. Pat. No. 11,754,724, the preferred time source is a global positioning system (GPS) device. For this invention, the time source can be GPS, IRIG, IEEE 1588 or any time protocol that can provide the required better than 100 ns time stamp accuracy. Whichever time source is selected, a single time source for both time stamps 55 and 56 is preferred. As long as the time stamps are accurately applied to the digitized data samples output from the respective analog-to-digital converters, a cross-spectrum calculation between the two sets of digitized data can be conducted as in that U.S. Pat. No. 11,754,724.

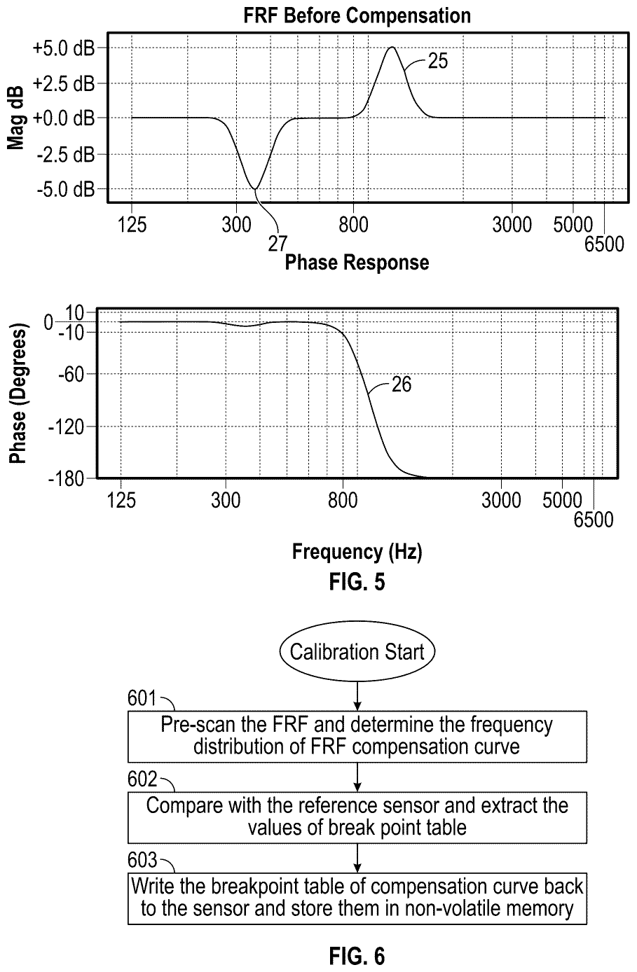

As seen in FIG. 6, sensor calibration is done using a slowly swept sine wave excitation 601 in a pre-scan operation (i.e., prior to any use of those sensors upon an object under test). Here it is the sensors themselves, and their vibration acceleration measurements at each frequency in a range of interest that are being tested. Deviations between the measurements of the sensors being calibrated and the reference sensor are extracted 602 to obtain the frequency response function (FRF) of the sensors being calibrated, the amplitude and phase for which are shown in FIG. 5. Different smart sensor models, but even different individual sensors of the same model, can have different FRF curves, depending upon the resonances associated with their physical structure. FRF can be expressed in the frequency domain as a complex number (a transfer function H(s)) with both real and imaginary components representing amplitude and phase responses, respectively, for the sensor being calibrated. Just like the amplitude response in FIG. 5, the phase response can also be visualized graphically, e.g., using a Bode plot. In any case, whether visualized graphically or not, to fully represent a sensor's FRF against a reference sensor, a set of frequencies ω have a real amplitude component |H(jω)| and an imaginary phase component arg H(jω). The complex number value at each frequency in the FRF can be represented and stored either in cartesian (z=x+iy) form or in polar (z=r ∠φ=r·(cos φ+i·sin φ)) form, storing either the real and imaginary components or the amplitude and phase components at each frequency in the range of interest. Likewise, FRF compensation calculations can be performed using the FRF values in either form.

The FRF of a sensor against a reference sensor can be quite complicated (the one in FIG. 5 is relatively modest), with potentially many changes in both amplitude and phase response over a frequency range of interest. Because of limited storage capacity in TEDS-like memory of a sensor, breakpoints need to be established 603 with essentially linear variation of amplitude and phase between those breakpoints to minimize the number of frequencies or data triplets needed to be stored. Breakpoints will be denser in frequency bands having rapid changes in response in either the amplitude or phase component but can be spaced further apart where the rate of change in the response is gradual, and thus more linear, so that interpolation techniques can be used between the breakpoints. The amount of data needed to describe the sensor FRF also depends upon the tolerance needed (e.g., more compensation data for a sensor with ±1.0 dB tolerance and less compensation data for a sensor with ±2.0 dB tolerance over the total frequency range of interest). An optimization algorithm can be readily developed to allocate frequency spacings such that the required tolerance is met within the available TEDS storage capacity. The compensation table of frequency-amplitude-phase data triplets are written at the various breakpoint frequencies over the frequency range of interest.

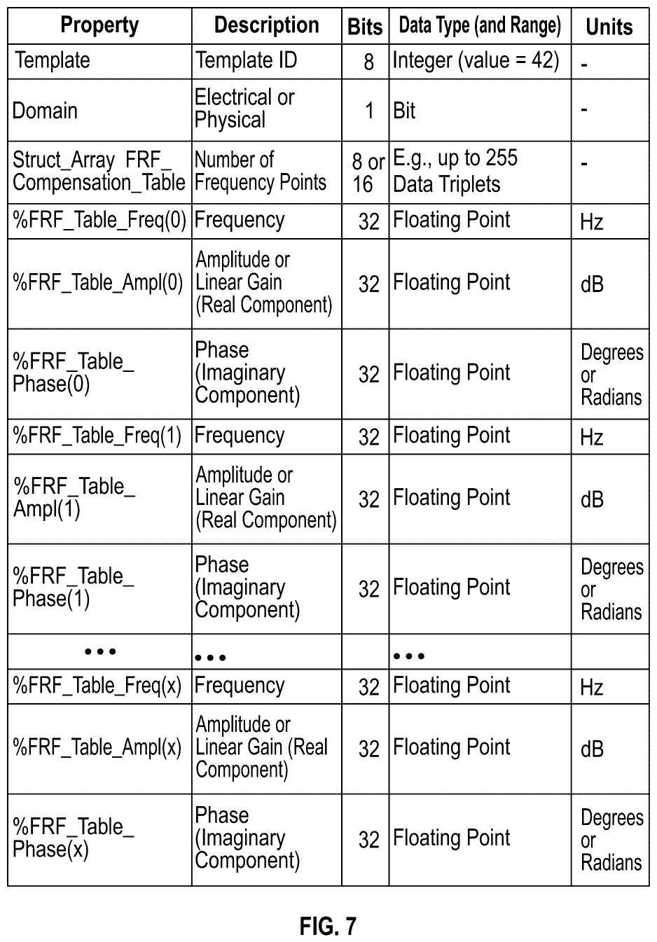

As seen in FIG. 7, the Transducer Electronic Data Sheet (TEDS) for each calibrated sensor stores a frequency-based correction table that represents the frequency response function (FRF) of that sensor. The table is generated as part of a sensor calibration that uses a highly accurate reference sensor for comparison. For the FRF correction table, a calibrated sensor's FRF is represented as a data triplet of (1) frequency, (2) amplitude, and (3) phase values in either polar or Cartesian form. In the latter case, the triplet would be (1) frequency, (2) real component, and (3) imaginary component. These can then be used to perform complex number multiplications or trigonometric operations upon digitized and transformed frequency domain sensor measurement signals. The TEDS may also include other information about the sensor (e.g., temperature-based sensitivity adjustments) as desired by the user.

Usually, after the calibration process above, the shaker's computer can immediately go to the data acquisition process as described below to validate if the FRF compensation result meets the tolerance. But this step is only optional.

In performing a vibration test upon an object mounted to the shaker table, sensor measurements are acquired as time domain data in up to three distinct axes, with typical desired tolerances being ±1.0 dB in the z (vertical) axis up to 5 kHz frequencies, ±1.5 dB in the z axis for frequencies greater than 5 kHz, and ±2.0 dB in the x and y (horizontal) axes. Measurement data is digitized (e.g., using an on-board analog-to-digital converter or ADC) and then converted into the frequency domain using a discrete-time transformation operation, such as the Fast Fourier Transform (FFT).

$$X 〈 k ) = {\sum }_{n = 0}^{N - 1} x ( n ) {e}^{- j 2 π kn / N}$$

where x(n) are samples of the time waveform of the sensor measurement, n being the sample index, N is the total number of samples or “block size”, k is the finite analysis frequency corresponding to FFT bin centers, and X(k) is the discrete Fourier transform of x(t). Typical data sampling rates range anywhere from 125 Hz to 16 kHz. Typical FFT block sizes are from 1024 to 4096 samples. Any of a variety of FFT algorithms (such as the Cooley-Tukey algorithm or a radix-2 decimation-in-frequency (DIF) algorithm) may be employed to perform the transformation. Each X(k) is a complex number whose polar coordinates are the amplitude and phase of a complex sinusoidal component. The FRF is usually obtained based on a so-called cross-spectral method after the FFT transforms to the measurements of sensor and reference sensor. To return to the time domain (after FRF compensation), an inverse transformation is used, as is well known.

After data acquisition using the calibrated sensors, a complex number FRF compensation method employs the stored TEDS-like data to correct sensor measurements of an object under test that is mounted upon the shaker table. The measurement correction is performed in the frequency domain after a time-domain to frequency-domain transformation of the sensor measurement signal using both real and imaginary parts (or amplitude and phase) of each sensor's FRF by means of complex number multiplications. Multiplications are a much faster operation in CPUs so the results can be obtained rapidly. For frequencies between the stored breakpoints, linear interpolation may be used to obtain the requisite amplitude and phase corrections for those intermediate frequencies.

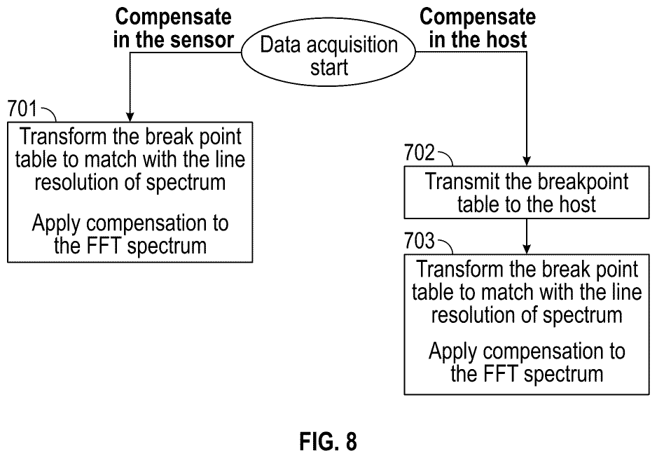

As seen in FIG. 8, the time domain to frequency domain transformation operation and the TEDS-based FRF compensation of measured data can be performed in the sensor itself, step 701 (using a smart transducer's on-board CPU), or alternatively the time domain (or frequency domain) measurement data may be transmitted along with the sensor's TEDS information to a host device, steps 702 and 703. In the latter case, the host device would perform the FRF compensation (or both the time-to-frequency domain transformation and FRF compensation). The host device can be either a single personal computer (PC), networked computer systems, or a cloud-based computing system.

If the frequency transformation is conducted on board (in the sensor), the FRF compensation 701 shall be conducted inside the sensor by its CPU. First the saved breakpoint table shall be retrieved and interpolated into an array of correction values. The interpolation can be done through polynomial interpolation methods or other means. The goal is to generate an array of complex number correction values that matches the resolution of FFT spectrum. These correction values are multipliers. After the FFT spectrum is generated, the multiplier array will be applied.

Alternatively, if the FRF compensation is conducted on a host computer, the corresponding breakpoint table must be transmitted 702 to the host computer either before the time domain data is transmitted or, the breakpoint table can be attached to each time domain data set. The host will conduct the same FRF compensation procedure 703 to correct the FFT spectrum.

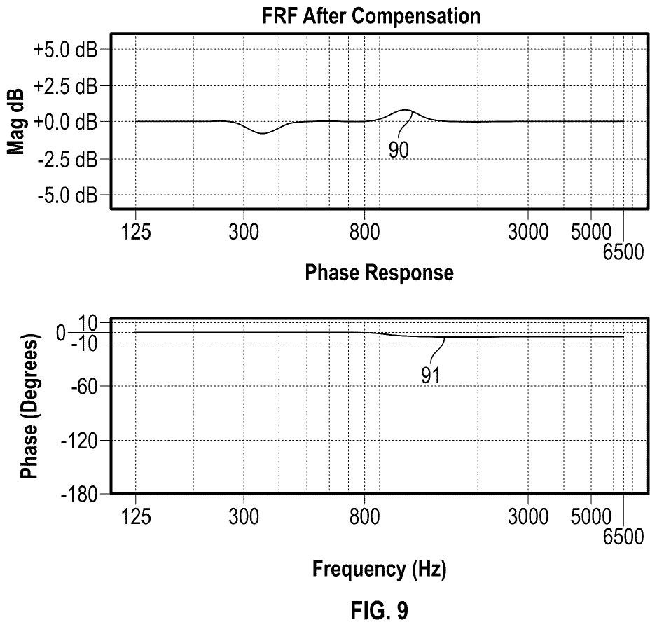

As seen in FIG. 9, after FRF compensation, the FFT spectrum 90 will be within the required tolerance, say ±1.0 dB, and the phase response 91 will be at or very near 0°.

The compensated measurement data in the frequency domain can then be transformed back into the time domain if it is needed. Various techniques, such as continuous convolution, can be used to generate continuous time data. With this technique, both frequency spectrum and time domain data have been corrected with their FRF discrepancies against a reference sensor.

What is claimed is:

1. A method of frequency domain calibration of a vibration sensor, comprising:
mounting a vibration sensor to be calibrated onto a shake table, the shake table also having mounted therein a reference sensor with an acceleration measurement accuracy better than one-tenth of a tolerance for the vibration sensor to be calibrated;
driving the shake table with a swept sine excitation to produce a vibration and measuring acceleration with both the vibration sensor to be calibrated and the reference sensor, digitized samples of acceleration measurements of both sensors receiving accurate time stamps from a shared reference time source;
comparing the measured accelerations to determine measurement deviations at each frequency of the swept sine excited vibration, the deviations representing a frequency response function (FRF) of the sensor being calibrated; and
storing a FRF correction table in a memory unit of the sensor being calibrated, the FRF correction table including entries at a set of frequency breakpoints in the form of data triplets of frequency, amplitude, and phase.

2. The method as in claim 1, wherein the amplitude and phase are represented in the FRF correction table by real and imaginary components of a multiplier for each given frequency of the frequency response function.

3. The method as in claim 1, wherein the amplitude and phase are represented in the FRF correction table in polar coordinates as radius and angle components for each given frequency of the frequency response function.

4. The method as in claim 1, wherein the vibration sensor to be calibrated is mounted on the shake table in the same direction as the reference sensor.

5. The method as in claim 1, wherein the set of frequency breakpoints is more frequency dense at those frequencies where the frequency response function of the sensor being calibrated changes more rapidly with frequency.

6. The method as in claim 5, wherein the number of stored breakpoints in the FRF correction table is based upon a selected acceleration measurement accuracy tolerance for the vibration sensor being calibrated and upon a storage capacity of the memory unit.

7. The method as in claim 1, wherein a computer controller is connected to the shake table via an amplifier and exciter that drives the shake table, the controller receiving feedback from the reference sensor.

8. A method of frequency response compensation of a calibrated vibration sensor, comprising
measuring acceleration over time by a calibrated vibration sensor, the sensor generating a digitized output time domain signal with time stamps;
transforming the digitized output time domain signal into a frequency domain generated output spectrum signal;
retrieving from a memory unit of the sensor stored entries of a frequency response function (FRF) correction table for each frequency, the FRF correction table including entries at a set of frequency breakpoints in the form of data triplets of frequency, amplitude, and phase; and
for each frequency of the transformed output spectrum signal, performing complex number multiplication by a corresponding complex multiplier value from the FRF correction table to obtain a compensated output spectrum signal.

9. The method as in claim 8, further comprising transforming the compensated output spectrum signal back into the time domain to obtain compensated acceleration measurements of the vibration sensor.

10. The method as in claim 8, wherein the amplitude and phase are represented in the FRF correction table by real and imaginary components of a complex multiplier value for each given frequency.

11. The method as in claim 8, wherein the amplitude and phase are represented in the FRF correction table in polar coordinates as radius and angle components for each given frequency.

12. The method as in claim 8, wherein transforming the digitized output time domain signal is performed by a processor on board the vibration sensor.

13. The method as in claim 8, wherein the digitized output time domain signal from the vibration sensor is transmitted with time stamps to a host computer and the transformation of the digitized output time domain signal into the frequency domain generated output spectrum signal is performed by the host computer.

14. The method as in claim 8, wherein performance of the complex number multiplication upon the transformed output spectrum signal is performed by a processor on board the vibration sensor.

15. The method as in claim 8, wherein the FRF correction table stored in the memory unit is transmitted from the vibration sensor to a host computer and performance of the complex number multiplication upon the transformed output spectrum signal is performed by the host computer.

16. The method as in claim 8, wherein for frequencies of the transformed output signal that are between frequency breakpoints, a complex multiplier value to be used in the complex number multiplication is interpolated from adjacent entries in the compensation table.

17. A shaker system, comprising:
a shake table;
a computer controller connected to the shake table via an amplifier and exciter that drives the shake table with a specified drive profile, the controller receiving feedback from a reference sensor mounted to the shake table, the reference sensor with an acceleration measurement accuracy better than one-tenth of a specified tolerance;
an object subject to vibration analysis which is mounted on the shake table;
at least one calibrated vibration sensor mounted on the object, the calibrated vibration sensor a memory unit storing a frequency response function (FRF) correction table of the sensor that includes entries at a set of frequency breakpoints in the form of data triplets of frequency, amplitude, and phase; and
a processor of vibration sensor acceleration measurements, the processor programmed to digitize and transform the measurements in the form of a time domain signal into a frequency domain to generate output spectrum signals, retrieve FRF correction table entries from the memory unit for each frequency of the transformed output spectrum signal, and perform complex number multiplication of amplitude and phase of the transformed output spectrum signal by a corresponding complex multiplier value from the compensation table to obtain a compensated signal.

18. The shaker system as in claim 17, wherein the processor further transforms the compensated output spectrum signal back into the time domain to obtain compensated acceleration measurements of the vibration sensor.

19. The shaker system as in claim 17, wherein the amplitude and phase in the FRF correction table are represented by real and imaginary components of a multiplier for a given frequency.
